(19) United States
(12) Patent Application Publication
(10) Pub. No.: US 2024/0052698 A1
(43) Pub. Date: Feb. 15, 2024

(54) ROLLER BLIND ASSEMBLY AND KIT

(71) Applicant: Antonio Marzilli, Mississauga (CA)

(72) Inventor: Antonio Marzilli, Mississauga (CA)

(21) Appl. No.: 18/330,442

(22) Filed: Jun. 7, 2023

Related U.S. Application Data
(60) Provisional application No. 63/397,014, filed on Aug. 11, 2022.

(51) Int. Cl. E06B 9/42

(52) U.S. Cl. CPC E06B 9/42; E06B 2009/425; E06B 2009/2417

(57) ABSTRACT

A roller blind assembly is securable between horizontally spaced apart first and second support brackets. The assembly includes a roller tube, a connector for securing one end of the roller tube to the first bracket, an actuator for securing the other end of the roller tube to the second bracket, and a blind supportable by the roller tube. The roller tube includes circumferentially spaced apart first and second grooves. The blind includes a bottom rail and a blind material having a first edge securable to the first groove, and an opposed second edge securable to the second groove. The blind material has alternating first and second strips with different light transmissibility. When secured to the roller tube, the blind material defines superposed front and rear segments. The front segment extends from the first edge to the bottom rail. The rear segment extends from the second edge to the bottom rail.

### CROSS-REFERENCE TO RELATED APPLICATIONS

This application claims the benefit of U.S. Provisional Application No. 63/397,014 filed on Aug. 11, 2022, which is incorporated by reference herein in its entirety.

### FIELD

This application relates generally to the field of window coverings, and more particularly to a roller blind assembly.

### INTRODUCTION

Roller blinds are well known. Such blinds are commonly used, for example, to selectively control the passage of light through openings (e.g., windows, glass doors, and the like) in residential, commercial, and industrial buildings.

### SUMMARY

The following is intended to introduce the reader to the detailed description that follows and not to define or limit the claimed subject matter.

In one aspect, a roller blind assembly securable between a first support bracket and a second support bracket horizontally spaced apart from the first support bracket is disclosed. The roller blind assembly includes a roller tube extending longitudinally from a first end to a second end, a connector configured to secure the first end of the roller tube to the first support bracket, an actuator configured to secure the second end of the roller tube to the second support bracket and a blind configured to be supported by the roller tube. The roller tube includes longitudinally extending first and second grooves. The first and second grooves are circumferentially spaced apart from each other. The blind includes a bottom rail and a blind material. The blind material has a first edge configured to be secured to the first groove and a second edge opposite the first edge configured to be secured to the second groove. The blind material includes a plurality of first strips and a plurality of second strips. Each of the first strips alternates with each of the second strips. The plurality of first strips have a lower light transmissibility than the plurality of second strips. When the blind material is secured to the roller tube, the blind material defines superposed front and rear blind segments. The front blind segment extends from the first edge to the bottom rail. The rear blind segment extends from the second edge to the bottom rail. Rotation of the roller tube in a first direction unwinds the front and rear blind segments from the roller tube. Rotation of the roller tube in a second direction opposite the first direction winds the front and rear blind segments onto the roller tube.

In some examples, each of the second strips have a second strip height, and the first and second grooves are circumferentially spaced apart by an arc length, the arc length having a predetermined value that is proportional to the second strip height.

In some examples, the arc length is substantially equal to the second strip height.

In some examples, when the blind material is in a substantially unwound position, rotation of the roller tube by the arc length in the first direction moves the blind material from a closed configuration, in which the first strips of one of the front and rear blind segments overlay the second strips of the other of the front and rear blind segments, to an open configuration, in which the second strips of one of the front and rear blind segments at least partially overlay the second strips of the other of the front and rear blind segments.

In some examples, more light passes through the blind material in the open configuration than the closed configuration.

In some examples, when the blind material is in the closed configuration, the blind material substantially blocks all light from passing therethrough.

In some examples, the first and second strips are arranged horizontally when the blind material is secured to the roller tube.

In some examples, the blind material extends continuously without interruption from the first edge to the second edge.

In some examples, the first and second grooves are radially opposed.

In some examples, the blind material is slidably connected to the bottom rail.

In some examples, the roller tube includes an interior cavity extending between the first and second ends, and the first and second grooves project inwardly into the interior cavity.

In some examples, the connector includes a body securable to the first support bracket and a collar rotatably coupled to the body, the collar being configured to engage at least one of the first and second grooves from within the interior cavity such that the roller tube and the collar rotate together, and, when the body is secured to the first support bracket, the collar rotates independently of the body.

In some examples, the roller blind assembly includes a pre-torsioned spring assembly having a first end securable to the body of the connector and a second end opposite the first end configured to engage at least one of the first and second grooves from within the interior cavity, the pre-torsioned spring assembly being configured to assist rotation of the roller tube in the second direction.

In some examples, the actuator includes a user-operated pull cord actuable between a retracted position and an extended position, and, when the actuator is secured to the second support bracket, downward actuation of the user-operated pull cord toward the extended position rotates the roller tube in the first direction.

In some examples, the actuator includes a) a bracket engagement member securable to the second support bracket; b) a rotary plate rotatably coupled to the bracket engagement member, the rotatory plate including a roller tube engagement member configured to engage at least one of the first and second grooves from within interior cavity such that the rotary plate and the roller tube rotate together; and c) a user-operated pull cord coupled to the rotary plate and actuable between a retracted position and an extended position, and, when the bracket engagement member is secured to the second support bracket, downward actuation of the user-operated pull cord toward the extended position rotates the roller tube in the first direction.

In some examples, the user-operated pull cord includes a lower grip portion that is semi-rigid or rigid.

In some examples, the blind further includes a first groove attachment member configured to secure to the first edge of the blind material to the first groove of the roller tube, and a second groove attachment member configured to secure the second edge of the blind material to second groove of the roller tube.

In some examples, the first and second grooves of the roller tube are sized to receive a respective one of the first and second groove attachment members.

In another aspect, a kit for a roller blind assembly that is securable between a first support bracket and a second support bracket horizontally spaced apart from the first support bracket is disclosed. The kit includes I) a roller tube extending longitudinally from a first end to a second end, II) a connector configured to secure the first end of the roller tube to the first support bracket, III) an actuator configured to secure the second end of the roller tube to the second support bracket, and IV) a blind configured to be supported by the roller tube. The roller tube includes longitudinally extending first and second grooves. The first and second grooves are circumferentially spaced apart from each other. The blind includes a bottom rail and a blind material. The blind material has a first edge configured to be secured to the first groove and a second edge opposite the first edge configured to be secured to the second groove. The blind material includes a plurality of first strips and a plurality of second strips. Each of the first strips alternates with each of the second strips. The plurality of first strips have a lower light transmissibility than the plurality of second strips. When the blind material is secured to the roller tube, the blind material defines superposed front and rear blind segments. The front blind segment extends from the first edge to the bottom rail. The rear blind segment extends from the second edge to the bottom rail. Rotation of the roller tube in a first direction unwinds the front and rear blind segments from the roller tube. Rotation of the roller tube in a second direction opposite the first direction winds the front and rear blind segments onto the roller tube.

In some examples, each of the second strips have a second strip height, and the first and second grooves are circumferentially spaced apart by an arc length, the arc length having a predetermined value that is proportional to the second strip height.

Other aspects and features of the teachings disclosed herein will become apparent to those ordinarily skilled in the art, upon review of the following description of the specific examples of the present disclosure.

### DRAWINGS

The drawings included herewith are for illustrating various examples of apparatuses and methods of the present disclosure and are not intended to limit the scope of what is taught in any way. In the drawings:

FIG. 1 is an exploded perspective view of an example roller blind assembly according to aspects of the teaching disclosed herein;

FIG. 2 is a perspective view of the roller blind assembly of FIG. 1, with the blind material shown in a closed configuration;

FIG. 3 is a perspective view of the roller blind assembly of FIG. 1, with the blind material shown in an open configuration;

FIG. 4 is a side view of the roller blind assembly of FIG. 1;

FIG. 5 is a perspective view of a roller tube of the roller blind assembly shown in FIG. 1;

FIG. 6 is a perspective view of a groove attachment member that may be used in the roller blind assembly of FIG. 1;

FIG. 7 is a partial side view of the roller blind assembly of FIG. 1, with the blind material in a substantially unwound position;

FIG. 8 is a partial side view of the roller blind assembly of FIG. 1, with the blind material in a fully unwound position;

FIG. 9 is a perspective view of a connector of the roller blind assembly shown in FIG. 1;

FIG. 10 is a perspective view of an actuator of the roller blind assembly shown FIG. 1, with a user-operated pull cord of the actuator in a retracted position;

FIG. 11 is a perspective view of the actuator of FIG. 10, with the user-operated pull cord of the actuator in an extended position;

FIG. 12 is a cutaway side view of another roller blind assembly according to aspects of the teaching disclosed herein; and

FIG. 13 is a side perspective view of a connector and a pre-torsioned spring assembly of the roller blind assembly shown in FIG. 12.

The drawings included herewith are for illustrating various examples of articles, methods, and apparatuses of the teaching of the present specification and are not intended to limit the scope of what is taught in any way.

### DETAILED DESCRIPTION

Various apparatuses or methods will be described below to provide an example of an embodiment of each claimed invention. No embodiment described below limits any claimed invention and any claimed invention may cover apparatuses and methods that differ from those described below. The claimed inventions are not limited to apparatuses and methods having all of the features of any one apparatus or method described below, or to features common to multiple or all of the apparatuses or methods described below. It is possible that an apparatus or method described below is not an embodiment of any claimed invention. Any invention disclosed in an apparatus or method described below that is not claimed in this document may be the subject matter of another protective instrument, for example, a continuing patent application, and the applicant(s), inventor(s) and/or owner(s) do not intend to abandon, disclaim or dedicate to the public any such invention by its disclosure in this document.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5% or 10%, for example, if this deviation does not negate the meaning of the term it modifies.

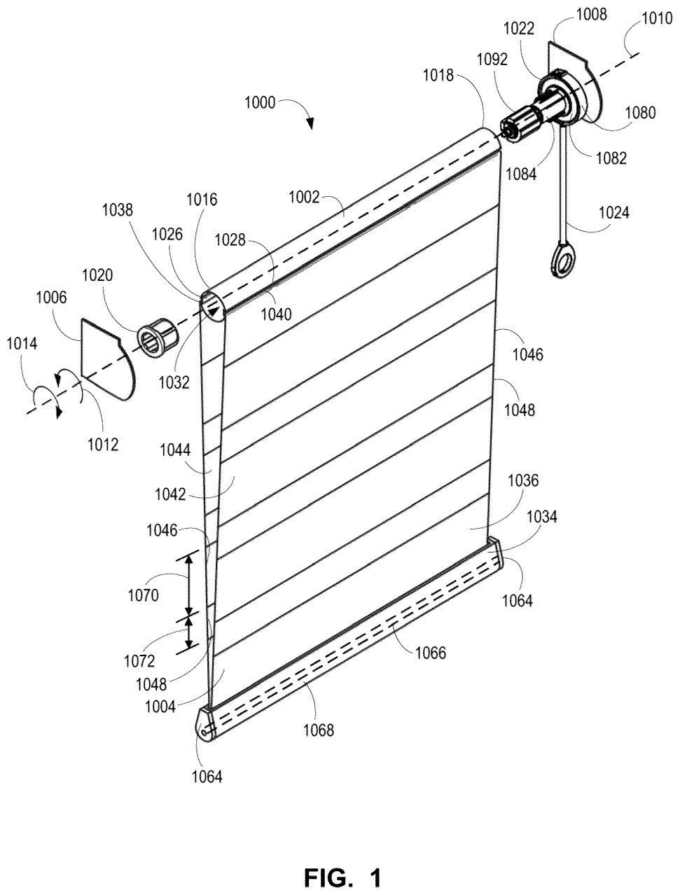

Referring first to FIG. 1, a roller blind assembly 1000 includes a roller tube 1002 and a blind 1004 supported by the roller tube 1002. In use, the roller blind assembly 1000 is positioned between a first support bracket 1006 and a second support bracket 1008 spaced horizontally apart from the first support bracket 1006. The first and second support brackets 1006, 1008 may be mounted at or above the upper end of a window, door frame, or any other structure through which light may pass. The blind 1004 can be lowered or raised from the roller tube 1002 by rotating the roller tube 1002 about its longitudinal axis 1010. In the example illustrated, rotation of the roller tube 1002 in a first direction 1012 unwinds the blind 1004 from the roller tube 1002 (i.e., lowers the blind 1004), and rotation of the roller tube 1002 in a second direction 1014 opposite the first direction 1012 winds the blind 1004 onto the roller tube 1002 (i.e., raises the blind 1004).

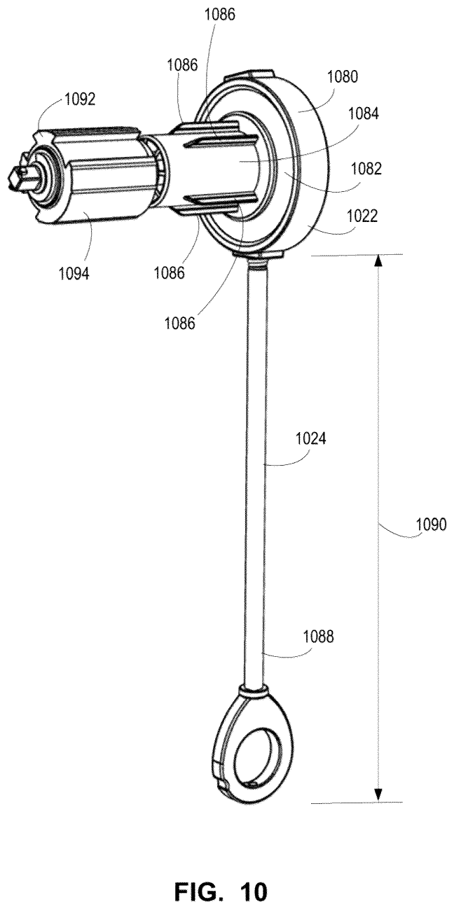

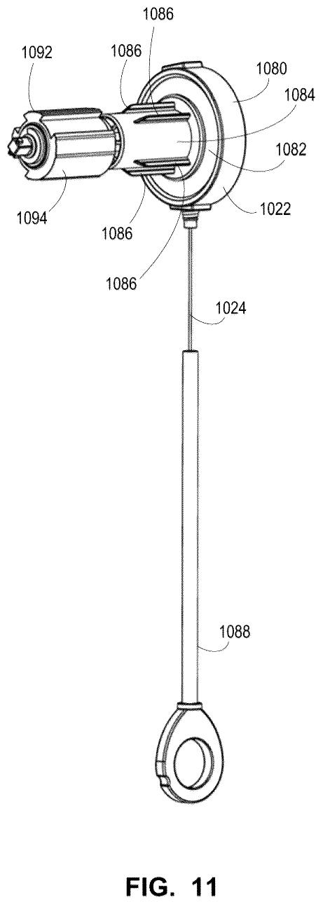

The roller tube 1002 extends longitudinally from a roller tube first end 1016 to a roller tube second end 1018. In the example illustrated, the roller blind assembly 1000 further includes a connector 1020 configured to secure the roller tube first end 1016 to the first support bracket 1006 and an actuator 1022 configured to secure the roller tube second 1018 to the second support bracket 1008. The actuator 1022, in the example illustrated, includes a user-operated pull cord 1024 that is actuable between a retracted position (FIG. 10) and an extended position (FIG. 11). A downward force by the user on the pull cord 1024 toward the extended position rotates the roller tube 1002 in the first direction 1012, thereby unwinding the blind 1004 from the roller tube 1002 (lowering the blind 1004). Alternatively, or in addition, the blind 1004 may be unwound from the roller tube 1002 by moving the blind 1004 generally downwardly by hand. In other examples, the actuator 1022 may include any other suitable type of user-operated element for raising and/or lower the blind 1004 (e.g., a chain).

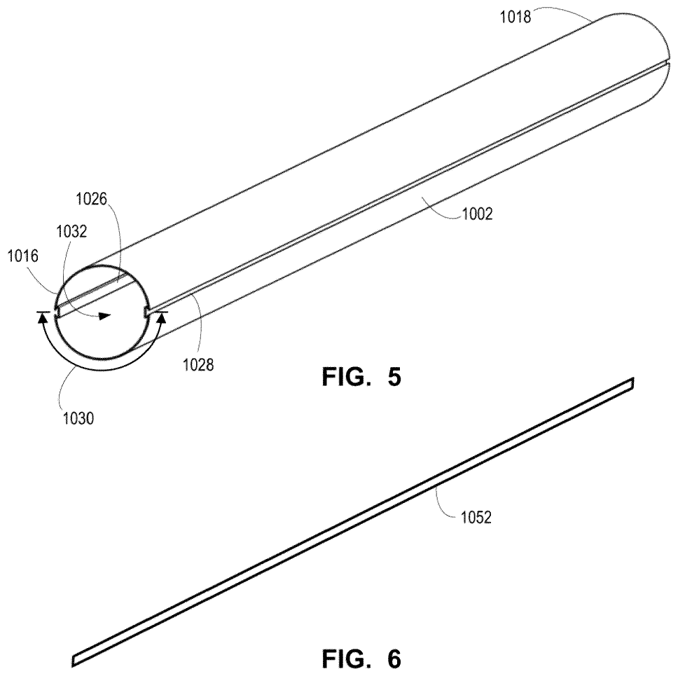

Referring to FIG. 5, the roller tube 1002 includes longitudinally extending first and second grooves 1026, 1028. The first and second grooves 1026, 1028 are circumferentially spaced apart from each other by an arc length 1030. As used herein, the arc length 1030 refers to the circumferential distance (not the linear distance) between the first and second grooves 1026, 1028. The first and second grooves 1026, 1028 are configured to retain opposite edges of a blind material to the roller tube 1002. In the example illustrated, the arc length 1030 is half of the circumference of the roller tube 1002 (i.e., the first and second grooves 1026, 1028 are radially opposed from each other). In other examples, the first and second grooves 1026, 1028 may be differently spaced. For example, the arc length 1030 between the first and second grooves 1026, 1028 may be a quarter of the circumference of the roller tube 1002.

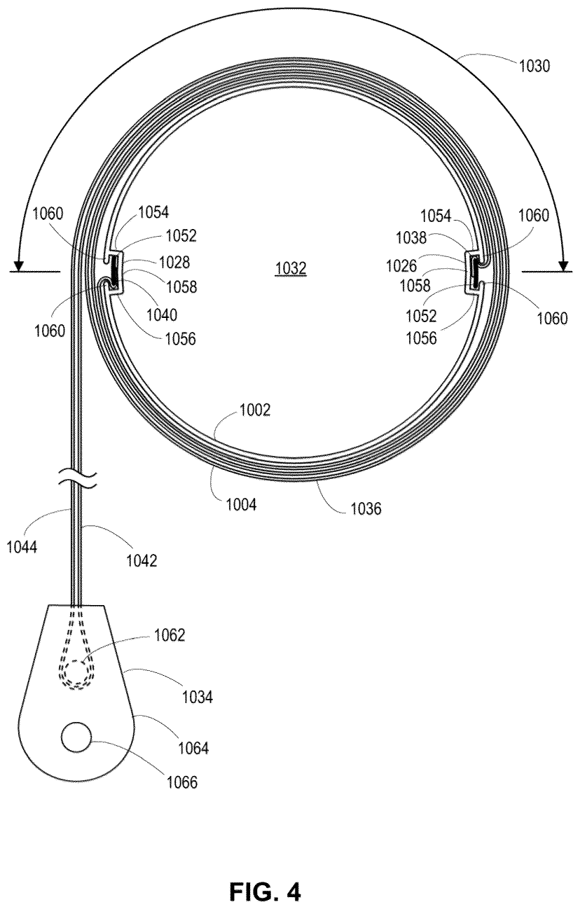

With reference to FIGS. 1 and 4, the blind 1004 includes a bottom rail 1034 and a blind material 1036. The blind material 1036 has a blind material first edge 1038 secured to the first groove 1026 and a blind material second edge 1040 opposite the blind material first edge 1038 secured to the second groove 1028. When the blind material 1036 is secured to the roller tube 1002, the blind material 1036 defines superposed front and rear blind segments 1042, 1044. The front blind segment 1042 extends from the blind material first edge 1038 to the bottom rail 1034, and the rear blind segment 1044 extends from the blind material second edge 1040 to the bottom rail 1034. Unwound portions of the front and rear blind segments 1042, 1044 extend generally vertically, giving the unwound portion of the blind material 1036 a general “U”-shaped side profile (e.g., see FIG. 4).

Rotation of the roller tube 1002 in the first direction 1012 unwinds the front and rear blind segments 1042, 1044 from the roller tube 1002 (i.e., lowering the blind 1004). Conversely, rotation of the roller tube 1002 in the second direction 1014 winds the front and rear blind segments 1042, 1044 onto the roller tube 1002 (i.e., raising the blind 1004).

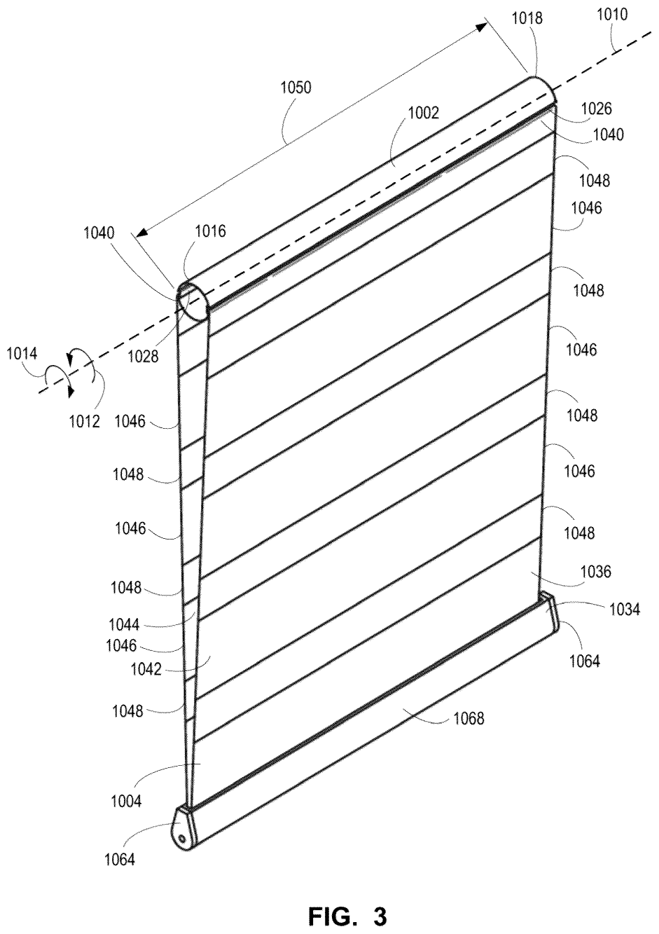

The roller tube 1002 may have any suitable dimensions. Referring to FIG. 3, the roller tube 1002 has a roller tube length 1050 between the roller tube first and second ends 1016, 1018. Typically, as in the example illustrated, the roller tube length 1050 corresponds to the width of the blind material 1036. In other examples, the roller tube length 1050 may be greater than the width of the blind material 1036.

The blind material 1036 may be any suitable material or combination of materials, such as, for example, textiles woven from natural and/or synthetic fibers. The size of the unrolled blind material 1036 (i.e., a length or height in the vertical dimension and a width in the horizontal dimension) may be similarly dimensioned, although larger, than the size of the window frame (or door frame) above which the roller blind assembly 1000 is to be positioned.

In the example illustrated, the blind material 1036 extends continuously without interruption from the blind material first edge 1038 to the blind material second edge 1040. Alternatively, the blind material 1036 may comprise two or more conjoined pieces of material. For example, the blind material 1036 may include a first piece of material defining the front blind segment 1042 and a second piece of material defining the rear blind segment 1044, with the first and second pieces of material joined (e.g., sewn together) at the bottom rail 1034.

Referring to FIGS. 1-3, the blind material 1038 includes alternating first strips and second strips 1046, 1048. The first and seconds strips 1046, 1048 are arranged horizontally when the blind material 1038 is secured to the roller tube 1002. The first strips 1046 have a lower light transmissibility than the second strips 1048. This means that more light can pass through the second strips 1048 than the first strips 1046. As an example, the first strips 1046 may be opaque (substantially blocking all light from passing therethrough) and the second strips 1048 may be translucent (allowing some light to pass therethrough). As another example, the first and second strips 1046, 1048 may each be translucent, with the second strips 1048 allowing a greater portion of light to pass therethrough than the first strips 1046 (i.e., while both translucent, the second strips 1048 are closer to transparent than the first strips 1046 on the transparent-to-opaque spectrum). As another example, the first strips 1046 may be translucent (blocking some light from passing therethrough) and the second strips 1048 may be transparent (substantially allowing all light to pass therethrough).

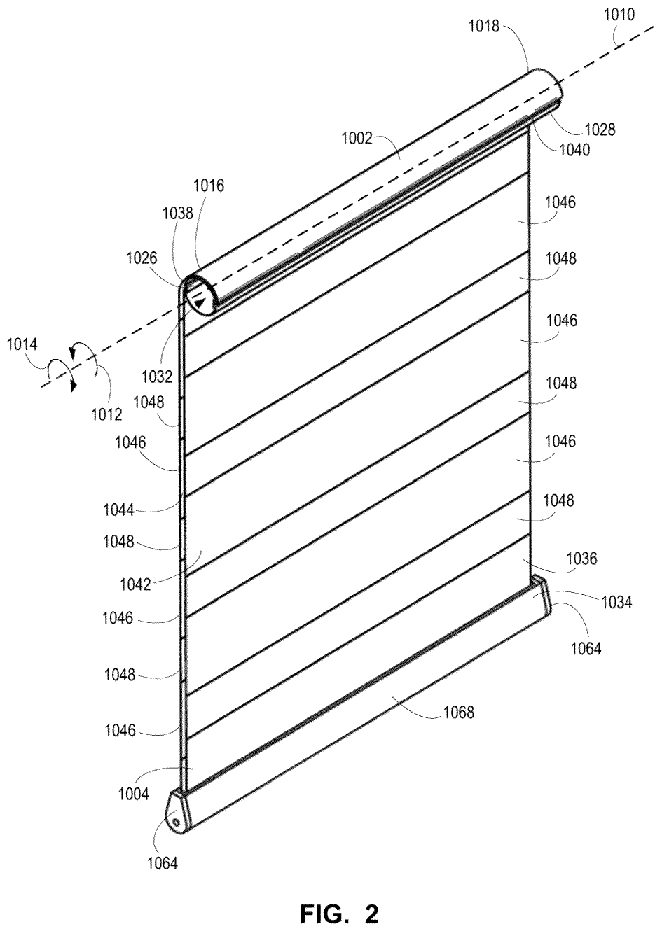

Referring to FIG. 1, the first strips 1046 have a first strip height 1070 and the second strips 1048 have a second strip height 1072. In some examples, the first and second strip heights 1070, 1072 are equal. In other examples, the second strip height 1072 is greater than the first strip height 1070. In the example illustrated, the first strip height 1070 is greater than the second strip height 1072. When the first strip height 1070 is greater than the second strip height 1072, the first strips 1046 can completely overlay the second strips 1048 when the blind material 1036 is in a closed configuration (see FIG. 2).

The blind material 1036 is movable relative to the roller tube 1002 between a plurality of closed configurations and an open configuration. When the blind material 1036 is in any one of the closed configurations, a) each first strip 1046 of the front blind segment 1042 overlays a respective one of the second strips 1048 of the rear blind segment 1044 and b) each first strip 1046 of the rear blind segment 1044 overlays a respective one of the second strips 1048 of the front blind segment 1042.

When the blind material 1036 is in the open configuration, each second strip 1048 of the front blind segment 1042 at least partially overlays a respective one of the second strips 1048 of the rear blind segment 1044. In some examples, when the blind material 1036 is in the open configuration, each second strip 1048 of the front blind segment 1042 fully overlays a respective one of the second strips of the rear blind segment 1044. In other examples, when the blind material 1036 is in the open configuration, each second strip 1048 of the front blind segment 1042 partially overlays a respective one of the second strips of the rear blind segment 1044.

More light can pass through the blind material 1036 in the open configuration than each of the plurality of closed configurations. This is due to the second strips 1048 having a higher light transmissibility than the first strips 1046. When the second strips 1048 of the front blind segment 1042 at least partially overlay the second strips 1048 of the rear blind segment 1044, the blind material 1038 blocks less light than when the first strips 1046 overlay the second strips 1048. Being able to move the blind material 1036 between the open and closed configurations allows a user to selectively vary the amount of light entering a room via that window or door.

The blind material 1036 is in a closed configuration when fully wound around the roller tube 1002, when substantially unwound from the roller tube 1002, and each position in between. That is, when stopped in any position between a fully wound position and a substantially unwound position, the blind material 1036 is in a closed configuration (hence the blind material 1036 has a plurality of closed configurations).

The blind material 1036 is in a closed configuration between fully wound and substantially unwound positions due to the first and second blind segments 1042, 1044 having different lengths. Referring to FIG. 4, the front blind segment 1042 has a front blind segment length from the bottom rail 1034 to the first groove 1026 and the rear blind segment 1044 has a rear blind segment length from the bottom rail 1034 to the second groove 1028. For clarity of illustration, the connector 1020 and the actuator 1022 are omitted from FIG. 4. When the blind material 1036 is in any position between the fully wound and substantially unwound positions, the rear blind segment length is longer than the front blind segment length by the arc length 1030. By design, when the front and rear blind segment lengths differ by the arc length 1030, the blind material 1036 is in a closed configuration—each of the first strips 1046 overlay a respective one of the second strips 1048.

FIG. 2 shows the blind material 1036 in one of the closed configurations. For clarity of illustration, the connector 1020 and the actuator 1022 are omitted from FIG. 2. In the example illustrated, each first strip 1046 of the front blind segment 1042 overlays a respective one of the second strips 1048 of the rear blind segment 1038, and each first strip 1046 of the rear blind segment 1044 overlays a respective one of the second strips 1048 of the front blind segment 1042. Effectively, each first strip 1046 overlays a respective one of the second strips 1048 when the blind material 1036 is in a closed configuration. The first strips 1046 have a lower light transmissibility than the second strips 1048. When the first strips 1046 overlay the second strips 1048, the blind material 1036 blocks light that would have passed therethrough had the blind material 1036 been in the open configuration (e.g., FIG. 3). The portion of light that is blocked by the blind material 1036 in a closed configuration depends on the light transmissibility of the first and second strips 1046, 1048. In one example, the blind material 1036 may substantially block all light from passing therethrough when in a closed configuration (i.e., black-out effect). In another example, the blind material 1036 may block between 60% and 100% of light from passing therethrough when in a closed configuration.

FIG. 3 shows the blind material 1036 in the open configuration. For clarity of illustration, the connector 1020 and the actuator 1022 are omitted from FIG. 3. In the example illustrated, each second strip 1048 of the front blind segment 1042 overlays a respective one of the second strips 1048 of the rear blind segment 1044. The second strips 1048 have a higher light transmissibility than the first strips 1046. Since the second strips 1048 of the front rear blind segment 1042 overlay the second strips 1048 of the rear blind segment 1044, the blind material 1036 blocks less light than it would in a closed configuration (e.g., FIG. 2).

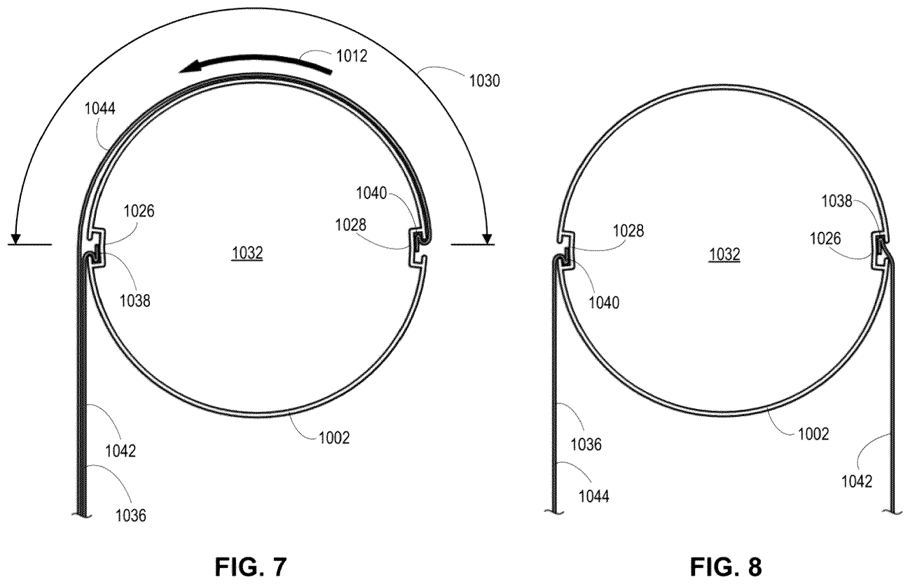

Referring to FIGS. 2 and 7, the blind material 1036 is shown in a substantially unwound position. As best shown in FIG. 7, when the blind material 1036 is in the substantially unwound position, only a small portion of the rear blind segment 1044 remains wound on the roller tube 1002. The small portion of the rear blind segment 1044 that remains wound on the roller tube 1002 has a length equal to the arc length 1030.

As shown in FIG. 2, when the blind material 1036 is in the substantially unwound position, it is in a closed configuration (the first strips 1046 overlap the second strips 1048). When the blind material 1036 is in the substantially unwound position, the rear blind segment length is longer than the front blind segment length by the arc length 1030. By design, when the front and rear blind segment lengths differ by the arc length 1030, the blind material 1036 is in a closed configuration—each of the first strips 1046 overlay a respective one of the second strips 1048.

Referring to FIGS. 3 and 8, the blind material 1036 is shown in a fully unwound position (all the blind material 1036 is unwound from the roller tube 1002). As best shown in FIG. 8, the front and rear segments 1042, 1044 of the blind material 1036 hang from opposite sides of the roller tube 1002 due to the circumferential spacing between the first and second grooves 1026, 1028. Comparing FIG. 8 to FIG. 7, rotation of the roller tube 1002 by the arc length 1030 in the first direction 1012 has unwound the small portion of the rear blind segment 1042 that was previously wound on the roller tube 1002.

As shown in FIG. 3, when the blind material 1036 is in the fully unwound position, it is also in the open configuration (the second strips 1048 of the front blind segment at least partially overlap the second strips 1048 of the rear blind segment 1044). When in the open configuration, the blind material 1036 allows an increased amount of light to pass therethrough relative to when the blind material 1036 is in a closed configuration.

When the blind material 1036 is in the substantially unwound position, rotation of the roller tube 1002 by the arc length 1030 in the first direction 1012 moves the blind material 1036 from a closed configuration (FIG. 2) to the open configuration (FIG. 3). Such rotation of the roller tube 1002 may be made, for example, by actuation of the user-operated pull cord 1024 of the actuator 1022. In some examples, rotating the roller tube 1002 to move the blind material 1036 from the substantially unwound position (FIG. 7) to the fully unwound position (FIG. 8) requires a downward force on the user-operated pull cord 1024. Urging the blind material 1036 downwardly by hand may not apply sufficient torque to rotate the roller tube 1002 in the first direction 112 when the blind material 1036 is in the substantially unwound position.

As shown in FIG. 3, when the blind material 1036 is in the fully unwound position, the front and rear blind segment lengths are substantially equal. In some examples, the blind material 1036 is designed so that the second strips 1048 of the front blind segment 1042 at least partially overlay the second strips 1048 of the rear blind segment 1044 when the front and rear blind segment lengths are substantially equal. As a result, when the front and rear blind segment length differ by the arc length 1030 (as is the case when the blind material 1036 is in a closed configuration), the overlay of the second strips 1048 is removed.

In some examples, the arc length 1030 (i.e., the circumferentially distance between the first and second grooves 1026, 1028) has a predetermined value that is proportional to at least one of the first and second strip heights 1070, 1072 (FIG. 1). As an example, the arc length 1030 may be substantially equal to the first strip height 1070. As another example, the arc length 1030 may be half the first strip height 1070. In the example illustrated, the arc length 1030 is substantially equal to the second strip height 1072.

Referring to FIG. 4, each of the blind material first and second edges 1038, 1040 are securable to a respective one of the first and second grooves 1026, 1028 of the roller tube 1002 in any manner that provides a secure connection therebetween. For example, the blind material first and second edges 1038, 1040 may be secured to the first and second grooves 1026, 1028, respectively, by double-sided tape, glue, hook-and-loop fastener, pins, clips, or a combination thereof. In the example illustrated, the blind 1004 further includes a pair of groove attachment members 1052. Each groove attachment member 1052 secures one of the blind material first and second edges 1038, 1040 to a respective one of the first and second grooves 1026, 1028 of the roller tube 1002.

With reference to FIGS. 4-6, the groove attachment members 1052 are sized to mate with either of the first and second grooves 1026, 1028. In some examples, the groove attachment members 1052 may be a polyvinyl chloride (PVC) extrusion. The blind material first edge 1038 can be attached to a respective one of the groove attachment members 1052 in any manner that provides a secure connection therebetween. For example, the blind material first edge 1038 may be attached to the groove attachment member 1052 with double-side tape. The blind material second edge 1040 may be attached to the other groove attachment member 1052 in a similar fashion. Once the blind material first and second edges 1038, 1040 are attached to respective groove attachment members 1052, each groove attachment member 1052 may be inserted into a respective one of the first and second grooves 1026, 1028 of the roller tube 1002 (e.g., FIG. 4).

Referring to FIG. 4, each of the first and second grooves 1026, 1028 is bounded at least in part by a pair of groove sidewalls 1054, 1056 and a groove end wall 1058 extending between inner ends of the groove sidewalls 1054, 1056. The groove sidewalls 1054, 1056 each have an inwardly facing catch 1060. The inwardly facing catches 1060 ensure retention of the groove attachment member 1052 by the first and second grooves 1026, 1028, and may inhibit unintended disengagement of the blind material first and second edges 1038, 1040 from the first and second grooves 1026, 1028, respectively. In some examples, the first and second grooves 1026, 1028 may include an adhesive on one or more of the groove sidewalls 1054, 1056 and the groove end wall 1058 to further ensure retention of the groove attachment members 1052.

Continuing to refer to FIG. 4, the blind material 1036 can be connected to the bottom rail 1034 in any manner that allows the blind material 1036 to slide relative to the bottom rail 1034 when the blind material 1036 is wound (raised) and unwound (lowered) from the roller tube 1002. In the example illustrated, the bottom rail 1034 includes a bottom roller 1062 positioned between the superposed front and rear blind segments 1042, 1044 of the blind material 1036 (in the region where the blind material 1036 folds to change direction). In such a position, the bottom roller 1062 may be dragged by the blind material 1036 as the blind material 1036 is wound (raised) and unwound (lowered) from the roller tube 1002.

Referring to FIG. 1, in the example illustrated, the bottom rail 1034 further includes a pair of optional end caps 1064. Each end cap 1064 is connectable to a respective end of the bottom roller 1062 (FIG. 4). When connected, the end caps 1064 ensure retention of the bottom roller 1062 by the blind material 1036 and may inhibit unintended disengagement of the bottom roller 1062 from the blind material 1036. In some examples, the end caps 1064 are provided with rotatable connections (e.g., bushings) that allow the bottom roller 1062 to rotate with respect to the end caps 1064.

The bottom rail 1034 may include an optional weighted member 1066. The weighted member 1066 adds weight to the blind material 1036 to facilitate unwinding the blind material 1036 from the roller tube 1002. The weight of the weighted member 1066 may be selected on several factors, such as, for example, the weight of the fabric and/or the height/width of the blind material 1036. The weighted member 1066 may take various configurations. In the example illustrated, the weighted member 1066 is a rod (broken lines in FIG. 1) that is secured between the end caps 1064.

Referring to FIG. 1, in the example illustrated, the bottom rail 1034 further includes an optional outer cover 1068. The outer cover 1068 extends between the end caps 1064 and encases the bottom roller 1062 and weighted member 1066. The outer cover 1068 may enhance the visual appearance of the bottom rail 1034 by hiding internal components. Alternatively, or in addition, the outer cover 1068 may protect the bottom roller 1062 and the weighted element 1066 from damage and/or tampering. Alternatively, or in addition, the outer cover 1068 may provide a convenient user grip for unwinding the blind material 1036 from the roller tube 1002 (i.e., to lower the blind material 1036).

With reference to FIGS. 1 and 5, in the example illustrated, the roller tube 1002 includes an interior cavity 1032 extending between the roller tube first and second ends 1016, 1018, and the first and second grooves 1026, 1028 project inwardly into the interior cavity 1032. The connector 1020 and the actuator 1022 and are each insertable into the interior cavity 1032 from the roller tube first end 1016 and the roller tube second end 1018, respectively.

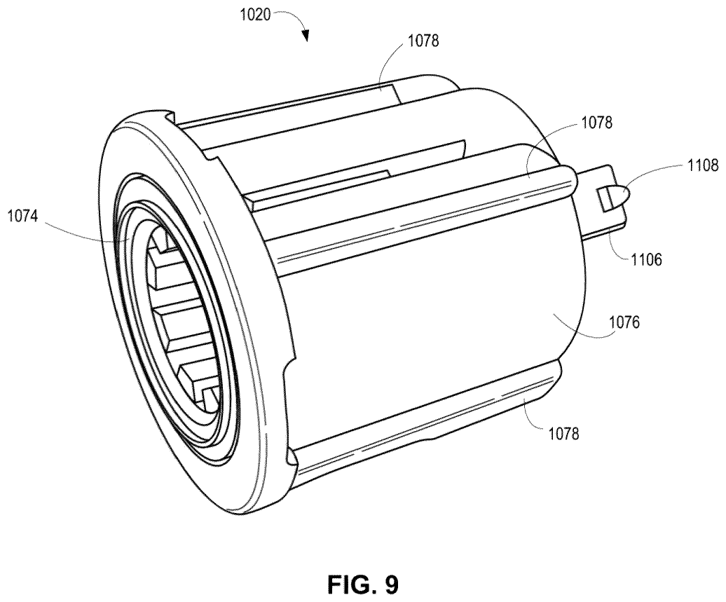

The connector 1020 can secure the roller tube first end 1016 to the first support bracket 1006 in any manner that allows the roller tube 1002 to rotate about its longitudinal axis 1010 with respect to the first support bracket 1006. Referring to FIG. 9, in the example illustrated, the connector 1020 includes a connector body 1074 securable to the first support bracket 1006 (FIG. 1) and a connector collar 1076 rotatably coupled to the connector body 1074. The connector collar 1076 has a generally cylindrical body that is positioned around the generally cylindrical outer surface of the connector body 1074.

With reference to FIGS. 1 and 9, the connector collar 1076 is configured to engage at least one of the first and second grooves 1026, 1028 from within the interior cavity 1032 of the roller tube 1002 such that the roller tube 1002 and the connector collar 1076 rotate together. When the connector body 1074 is secured to the first support bracket 1006, the collar 1076 rotates independently of the connector body 1074. Accordingly, rotation of the roller tube 1002 about its longitudinal axis 1010 rotates the connector collar 1076 independently of the connector body 1074.

In the example illustrated, the collar 1076 includes a plurality of groove engagement ribs 1078. When the connector 1020 is inserted within the interior cavity 1032 of the roller tube 1002, a pair of the groove engagement ribs 1078 mesh with respective ones of the first and second grooves 1026, 1028, and thereby rotationally interlock the connector collar 1076 and the roller tube 1002. As such, the roller tube 1002 and the connector collar 1076 of the connector 1020 may rotate together. The external diameter of the connector collar 1076 (including the groove engagement ribs 1078) is slightly smaller than the internal diameter of roller tube 1002. In this way, the connector 1020 may fit snuggly within the interior cavity 1032 of the roller tube 1002.

The actuator 1022 can secure the roller tube second end 1018 to the second support bracket 1008 in any manner that allows the roller tube 1002 to rotate about its longitudinal axis 1010 with respect to the second support bracket 1008. The actuator 1022 is a publicly available component which is described as a ‘main body’ in Canadian Patent No. 2,895,060, the entire contents of which are hereby incorporated by reference.

Referring to FIG. 10, in the example illustrated, the actuator 1022 includes a bracket engagement member 1080 securable to the second support bracket 1008 (FIG. 1), a rotary plate 1082 rotatably coupled to the bracket engagement member 1080, and a user-operated pull cord 1024 coupled to the rotatory plate 1082. When the bracket engagement member 1080 is secured to the second support bracket 1008, the rotary plate 1082 rotates independently of the bracket engagement member 1080.

The rotary plate 1082 includes a roller tube engagement member 1084. With reference to FIGS. 1 and 10, the roller tube engagement member 1084 is configured to engage at least one of the first and second grooves 1026, 1028 from within the interior cavity 1032 of the roller tube 1002 such that the roller tube 1002 and the rotary plate 1082 rotate together. Accordingly, rotation of the rotary plate 1076 causes the roller tube 1002 to rotate about its longitudinal axis 1010 independently of the bracket engagement member 1080 (and the second support bracket 1008).

In the example illustrated, the roller tube engagement member 1084 includes a plurality of ribs 1086. When the roller tube engagement member 1084 is inserted within the interior cavity 1032 of the roller tube 1002, a pair of the ribs 1086 mesh with respective ones of the first and second grooves 1026, 1028, and thereby rotationally interlock the rotary plate 1082 and the roller tube 1002. As such, the roller tube 1002 and the rotary plate 1082 of the actuator 1022 may rotate together. The external diameter of the roller tube engagement member 1084 (including the ribs 1086) is slightly smaller than the internal diameter of roller tube 1002. In this way, the roller tube engagement member 1084 may fit snuggly within the interior cavity 1032 of the roller tube 1002.

The user-operated pull cord 1024 extends from the rotary plate 1082 and is actuable between a retracted position (FIG. 10) and an extended position (FIG. 11). The user-operated pull cord 1024 is biased to the retracted position (e.g., with any suitable biasing member, such as, for example, a spring). A user may actuate the pull cord 1024 downwardly toward the extended position by overcoming a biasing force urging the pull cord into the retracted position. When the user releases the pull cord 1024, the biasing force returns the pull cord 1024 back toward the retracted position.

When the bracket engagement member 1080 is secured to the second support bracket 1008, downward actuation of the user-operated pull cord 1024 toward the extended position rotates the roller tube 1002 in the first direction 1012 (FIG. 1). The downward actuation of the pull cord 1024 rotates the rotary plate 1082, which in turn rotates the roller tube 1002. Rotation of the roller tube 1002 in the first direction 1012 unwinds the blind material 1036 therefrom (lowering the blind). As a result, downward actuation of the user-operated pull cord 1024 toward the extended position lowers the blind material 1036. In some examples, a user may actuate the user-operated pull cord 1024 downwardly toward the extended position several times in succession until a desired amount of the window, door frame, or the like is obscured by the blind material 1036.

In the example illustrated, the user-operated pull cord 1024 includes a lower grip portion 1088 (also referred to herein as a wand 1088). The wand 1088 is semi-rigid or rigid and provides a convenient user grip for actuating the pull cord 1024. The lower grip portion 1088 may be formed of any suitable semi-rigid to rigid material (e.g., medium-to-hard plastic, rubber, metal, or a combination thereof).

Referring to FIG. 10, the pull cord 1024 has an external length 1090 in the retracted position between an underside surface of the actuator 1022 and a bottom end of the pull cord 1024. The external length 1090 can be any suitable dimension. In cases where the roller blind assembly 1000 is positioned at the upper end of a tall window or door frame, it may be advantageous to increase the external length 1090 of the pull cord 1024. All else being equal, a pull cord 1024 with a longer external length 1090 will be easier to reach (and grab) than a pull cord 1024 with a shorter external length 1090.

Referring to FIG. 1, the roller blind assembly 1000 further includes an optional stopper member 1092. The stopper member 1092 is a publicly available component which is described in Canadian Patent No. 2,895,060, the entire contents of which are hereby incorporated by reference.

In the example illustrated, the stopper member 1092 is affixed to the roller tube engagement member 1084 of the actuator 1022 and positionable within the interior cavity 1032 of the roller tube 1002. The stopper member 1092 is movable between a locked position, in which the stopper member 1092 inhibits rotation of the roller tube 1002 in the second direction 1014, and an unlocked position in which rotation of the roller tube 1002 in the second direction 1014 is uninhibited. In the locked position, the stopper member 1092 inhibits the blind material 1036 from drifting upwardly (i.e., winding around the roller tube 1002). In other words, when the stopper member 1092 is in the locked position, the stopper member 1092 inhibits rotation of the roller tube 1002 that would raise the blind material 1036 (rotation in the second direction 1014 in FIG. 1). The stopper member 1092 functions to maintain the blind material 1036 stationary in any position between the fully wound position and the fully unwound position.

The stopper member 1092 is configured to engage at least one of the first and second grooves 1026, 1028 from within the interior cavity 1032 of the roller tube 1002 such that the stopper member 1092 rotates with the roller tube 1002. Referring to FIG. 10, in the example illustrated, the external surface of the stopper member 1092 includes a wedge 1094. When the stopper member 1092 is positioned within the interior cavity 1032 of the roller tube 1002, the wedge 1094 meshes between the first and second grooves 1026, 1028, and thereby rotationally interlock the stopper member 1092 and the roller tube 1002. As such, the roller tube 1002 and the stopper member 1092 may rotate together. The external diameter of the stopper member 1092 (including the wedge 1094) is slightly smaller than the internal diameter of roller tube 1002. In this way, the stopper member 1092 may fit snuggly within the interior cavity 1032 of the roller tube 1002.

When the blind material 1036 in the fully unwound position (as shown in FIGS. 3 and 8), actuation of the user-operated pull cord 1024 toward the extended position moves the stopper member 1092 from the locked position to the unlocked position. When the stopper member 1092 is in the unlocked position, rotation of the roller tube 1002 in the second direction 1014 (FIG. 1) is uninhibited. Accordingly, when the stopper member 1092 is in the unlocked position, the blind material 1036 may be wound onto the roller tube 1002 to raise the blind 1004.

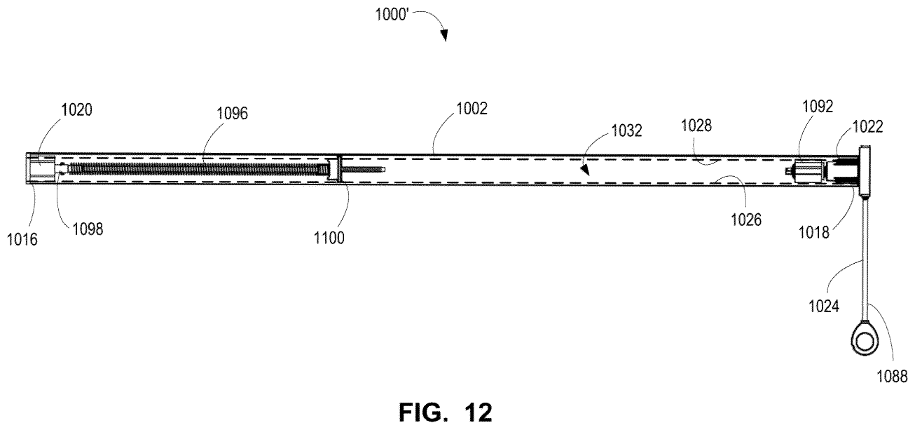

Reference is now made to FIG. 12, which illustrates another example roller blind assembly, referred to generally as 1000′. The roller blind assembly 1000′ shown in FIG. 12 is analogous to the roller blind assembly 1000 shown in FIG. 1, except for the inclusion of a pre-torsioned spring assembly 1096. Elements of roller blind assembly 1000′ having similar structure and/or performing similar function as those in the roller blind assembly 1000 are identified with like reference characters. For clarity of illustration, the blind 1004 of the roller blind assembly 1000′ is omitted from FIG. 12.

The pre-torsioned spring assembly 1096 has a first end 1098 securable to the connector body 1074, and a second end 1100 opposite the first end 1098 configured to engage at least one of the first and second grooves 1026, 1028 from within the interior cavity 1032 of the roller tube 1002. The pre-torsioned spring assembly 1096 is configured to assist rotation of the roller tube 1002 in the second direction 1014 (FIG. 1). For example, the pre-torsioned spring assembly 1096 may impart a biasing torque on the roller tube 1002 to reduce the external force required to raise the blind 1004 (FIG. 1). In some examples, when the stopper member 1092 moves from the locked position to the unlocked position, the pre-torsioned spring assembly 1096 automatically raises the blind 1004. The pre-torsioned spring assembly 1096 is a publicly available component which is described in U.S. Pat. No. 11,286,715, the entire contents of which are hereby incorporated by reference.

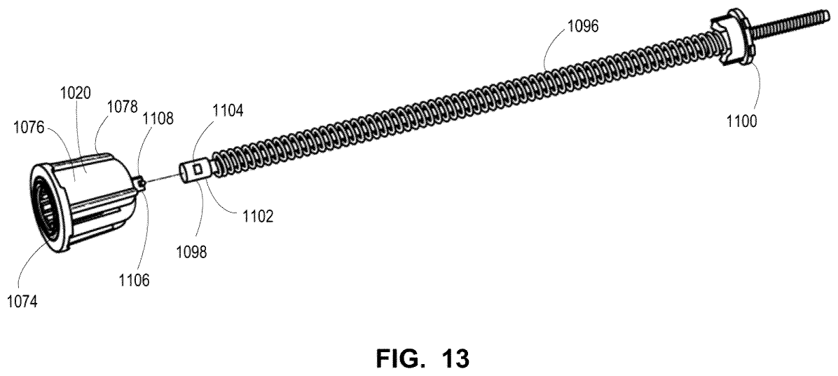

The pre-torsioned spring assembly 1096 can be coupled to the connector body 1074 of the connector 1020 in any suitable fashion. Referring to FIG. 13, in the example illustrated, the first end 1098 of the pre-torsioned spring assembly 1096 includes a coupling collar 1102 that has a pair of opposed openings 1104. The connector body 1074 includes an insertion end 1106 that has a pair of tabs 1108. The coupling collar 1102 is sized to receive the insertion end 1106 of the connector body 1074. When the insertion end 1106 is received in the coupling collar 1102, each tab 1108 can be aligned and engaged with a respective one of the openings 1104. In the example illustrated, the insertion end 1106 may be characterized as a ‘male’ connector, and the coupling collar 1102 may be characterized as a ‘female’ connector. It will be appreciated that in one or more alternative examples, coupling collar 1102 may be configured as a ‘male’ connector and insertion end 1106 may be configured as a ‘female’ connector.

Also disclosed herein is a kit for a roller blind assembly. The kit includes a roller tube 1002, a blind 1004, a connector 1020, and an actuator 1022. The kit may be assembled by its purchaser or an installer in any desired location. In some examples, the kit further includes a stopper member 1092. Alternatively, or in addition, the kit may include a pre-torsioned spring assembly 1096.

While the above description provides examples of one or more apparatuses or methods, it will be appreciated that other apparatuses or methods may be within the scope of the accompanying claims.

1. A roller blind assembly securable between a first support bracket and a second support bracket, the second support bracket horizontally spaced apart from the first support bracket, the roller blind assembly comprising:
a roller tube extending longitudinally from a first end to a second end, the roller tube comprising longitudinally extending first and second grooves, wherein the first and second grooves are circumferentially spaced apart from each other;
a connector configured to secure the first end of the roller tube to the first support bracket;
an actuator configured to secure the second end of the roller tube to the second support bracket; and
a blind configured to be supported by the roller tube, the blind comprising:
a bottom rail; and
a blind material comprising a first edge configured to be secured to the first groove, and a second edge opposite the first edge configured to be secured to the second groove, the blind material comprising a plurality of first strips and a plurality of second strips, wherein each of the first strips alternates with each of the second strips, the plurality of first strips having a lower light transmissibility than the plurality of second strips,
wherein, when the blind material is secured to the roller tube, the blind material defines superposed front and rear blind segments, the front blind segment extending from the first edge to the bottom rail, the rear blind segment extending from the second edge to the bottom rail,
wherein rotation of the roller tube in a first direction unwinds the front and rear blind segments from the roller tube, and rotation of the roller tube in a second direction opposite the first direction winds the front and rear blind segments onto the roller tube.

2. The roller blind assembly of claim 1, wherein each of the second strips have a second strip height, wherein the first and second grooves are circumferentially spaced apart by an arc length, the arc length having a predetermined value that is proportional to the second strip height.

3. The roller blind assembly of claim 2, wherein the arc length is substantially equal to the second strip height.

4. The roller blind assembly of claim 2, wherein, when the blind material is in a substantially unwound position, rotation of the roller tube by the arc length in the first direction moves the blind material from
a) a closed configuration, in which the first strips of one of the front and rear blind segments overlay the second strips of the other of the front and rear blind segments, to
b) an open configuration, in which the second strips of one of the front and rear blind segments at least partially overlay the second strips of the other of the front and rear blind segments.

5. The roller blind assembly of claim 4, wherein more light passes through the blind material in the open configuration than the closed configuration.

6. The roller blind assembly of claim 4, wherein, when the blind material is in the closed configuration, the blind material substantially blocks all light from passing therethrough.

7. The roller blind assembly of claim 1, wherein the first and second strips are arranged horizontally when the blind material is secured to the roller tube.

8. The roller blind assembly of claim 1, wherein the blind material extends continuously without interruption from the first edge to the second edge.

9. The roller blind assembly of claim 1, wherein the first and second grooves are radially opposed.

10. The roller blind assembly of claim 1, wherein the blind material is slidably connected to the bottom rail.

11. The roller blind assembly of claim 1, wherein the roller tube comprises an interior cavity extending between the first and second ends, and the first and second grooves project inwardly into the interior cavity.

12. The roller blind assembly of claim 11, wherein the connector comprises:
a body securable to the first support bracket; and
a collar rotatably coupled to the body, the collar being configured to engage at least one of the first and second grooves from within the interior cavity such that the roller tube and the collar rotate together,
wherein, when the body is secured to the first support bracket, the collar rotates independently of the body.

13. The roller blind assembly of claim 12, further comprising a pre-torsioned spring assembly having a first end securable to the body of the connector, and a second end opposite the first end configured to engage at least one of the first and second grooves from within the interior cavity, wherein the pre-torsioned spring assembly is configured to assist rotation of the roller tube in the second direction.

14. The roller blind assembly of claim 1, wherein the actuator comprises a user-operated pull cord actuable between a retracted position and an extended position, wherein, when the actuator is secured to the second support bracket, downward actuation of the pull cord toward the extended position rotates the roller tube in the first direction.

15. The roller blind assembly of claim 11, wherein the actuator comprises:
a bracket engagement member securable to the second support bracket;
a rotary plate rotatably coupled to the bracket engagement member, the rotatory plate comprising a roller tube engagement member configured to engage at least one of the first and second grooves from within interior cavity such that the rotary plate and the roller tube rotate together; and
a user-operated pull cord coupled to the rotary plate and actuable between a retracted position and an extended position,
wherein, when the bracket engagement member is secured to the second support bracket, downward actuation of the user-operated pull cord toward the extended position rotates the roller tube in the first direction.

16. The roller blind assembly of claim 15, wherein the user-operated pull cord comprises a lower grip portion that is semi-rigid or rigid.

17. The roller blind assembly of claim 1, wherein the blind further comprises:
a first groove attachment member configured to secure to the first edge of the blind material to the first groove of the roller tube; and
a second groove attachment member configured to secure the second edge of the blind material to second groove of the roller tube.

18. The roller blind assembly of claim 17, wherein the first and second grooves of the roller tube are sized to receive a respective one of the first and second groove attachment members.

19. A kit for a roller blind assembly that is securable between a first support bracket and a second support bracket, the second support bracket horizontally spaced apart from the first support bracket, the roller blind assembly comprising:
I) a roller tube extending longitudinally from a first end to a second end, the roller tube comprising longitudinally extending first and second grooves, wherein the first and second grooves are circumferentially spaced apart from each other;
II) a connector configured to secure the first end of the roller tube to the first support bracket;
III) an actuator configured to secure the second end of the roller tube to the second support bracket; and
IV) a blind configured to be supported by the roller tube, the blind comprising:
a bottom rail; and
a blind material comprising a first edge configured to be secured to the first groove, and a second edge opposite the first edge configured to be secured to the second groove, the blind material comprising a plurality of first and a plurality of second strips, wherein each of the first strips alternates with each of the second strips, the plurality of first strips having a lower light transmissibility than the plurality of second strips, wherein, when the blind material is secured to the roller tube, the blind material defines superposed front and rear blind segments, the front blind segment extending from the first edge to the bottom rail, the rear blind segment extending from the second edge to the bottom rail,
wherein rotation of the roller tube in a first direction unwinds the front and rear blind segments from the roller tube, and rotation of the roller tube in a second direction opposite the first direction winds the front and rear blind segments onto the roller tube.

20. The kit of claim 19, wherein each of the second strips have a second strip height, wherein the first and second grooves are circumferentially spaced apart by an arc length, the arc length having a predetermined value that is proportional to the second strip height.
